(19) United States
(12) Patent Application Publication
(10) Pub. No.: US 2015/0078016 A1
(43) Pub. Date: Mar. 19, 2015

(54) ANTI-THEFT COLLAR FOR AN LED LIGHT BULB HAVING COOLING FINS

(71) Applicant: Switch Bulb Company, Inc., San Jose, CA (US)

(72) Inventors: Andrew WEBB, San Jose, CA (US); Roget RATCHFORD, Menlo Park, CA (US); Vanvisa ATTASET, San Francisco, CA (US)

(73) Assignee: SWITCH BULB COMPANY, INC., San Jose, CA (US)

(21) Appl. No.: 14/029,733

(22) Filed: Sep. 17, 2013

(51) Int. Cl. F21V 15/00

(52) U.S. Cl. CPC F21V 15/005
USPC 362/377

(57) ABSTRACT

An anti-theft collar for preventing removal of a light-emitting diode (LED) bulb having cooling fins when the LED bulb is installed in a socket housing of a light fixture. The anti-theft collar includes a wall portion configured to enclose at least a portion of the LED bulb and at least a portion of the socket housing. The anti-theft collar also includes a pair of ribs configured to engage with the cooling fins to inhibit rotation of the LED bulb with respect to the anti-theft collar when the anti-theft collar is installed. The anti-theft collar also includes one or more features configured to inhibit movement of the anti-theft collar with respect to the socket housing of the light fixture.

### BACKGROUND

1. Field

The present disclosure relates generally to an anti-theft system for a light emitting diode (LED) bulb, and more specifically to an anti-theft collar that engages the cooing fins of an LED bulb to prevent the LED bulb's removal from a light fixture.

2. Description of Related Art

Light-emitting diode (LED) bulbs have emerged as a practical and attractive solution for residential and commercial lighting applications. In general, LED bulbs are characterized as being an energy-efficient and long-lasting alternative to incandescent and fluorescent light bulbs. Some LED bulbs have a form factor similar to a standard incandescent bulb, facilitating interchangeability with existing lighting fixtures. One example of an LED bulb that can be used with a standard light-bulb socket is provided in U.S. Pub. No. US2013/0010480, which is incorporated by reference herein in its entirety.

As the use of LED bulbs becomes more widespread, it may be appropriate to address concerns with potential theft or unauthorized removal of LED bulbs. Factors such as cost, durability, and visual appeal may lead to a greater risk of theft for some LED bulbs as compared to traditional (non-LED) light bulbs, which are relatively inexpensive and ubiquitous. For example, while LED bulbs offer long-term energy and cost savings and require less frequent replacement, LED bulbs typically have a higher initial cost as compared to traditional incandescent bulbs. Additionally, some LED bulbs may be perceived as novel and produce aesthetically pleasing light.

The risk of theft may be particularly high for LED bulbs that are installed in hotels, offices, or public areas that have minimal supervision. Most traditional light-bulb fixtures are not designed to prevent theft of an installed light bulb. In fact, many traditional light-bulb fixtures include an Edison screw socket or bayonet mount that are designed for ease of light bulb installation and removal. Accordingly, there is a need for a device that can deter or prevent removal of an LED light bulb from the socket of a light fixture.

### BRIEF SUMMARY

An exemplary embodiment is directed to a collar for preventing removal of an LED bulb installed in a socket housing of a light fixture. The LED bulb has a plurality of cooling fins to dissipate heat created by the LEDs. The collar includes a wall portion configured to enclose at least a portion of the socket housing. The collar also includes an upper portion that extends from a first end of the wall portion. The collar also includes a pair of ribs extending inward from an inner surface of the upper portion of the collar. The ribs are configured to mechanically engage with at least one fin of the LED light bulb and to inhibit rotation of the LED light bulb with respect to the collar when the collar is installed.

In some embodiments, an opening is formed in the wall portion. The opening is configured to at least partially encircle a key of the light fixture when the collar is installed to inhibit rotation of the collar with respect to the light fixture by mechanically engaging with the key.

In some embodiments, a lower portion extends from a second end of the wall portion. The lower portion has an upper surface configured to engage with an opposing lower surface of the socket housing to inhibit motion of the collar in a direction along a central axis of the LED bulb. In some embodiments, the collar includes a lower portion instead of an opening to inhibit movement of the collar with respect to the socket housing.

In some embodiments, the collar is formed from two pieces that are configured to be mechanically joined by one or more mechanical interlocks. The two pieces may or may not be symmetric or identical to each other. In some embodiments, each mechanical interlock includes at least one tab portion on a first of the two pieces, and at least one slot portion on a second of the two pieces. The tab portion and the slot portion are configured to interlock with each other. In some cases, the tab portion includes a beveled leading edge to facilitate installation and the tab portion includes a catch barb to inhibit removal of the collar after installation. In some cases, the collar is formed from more than two pieces.

In some cases, the pair of ribs are perpendicular to the inner surface of the upper portion. The pair of ribs may be separated by a gap that is approximately the width of one cooling fin of the plurality of cooling fins. The thickness of the ribs may be less than the uniform gap between each of the plurality of cooling fins.

### DESCRIPTION OF THE FIGURES

FIG. 1 depicts an exemplary collar installed on a lighting fixture.

FIG. 2 depicts an exemplary collar that includes a lower portion.

FIG. 3 depicts a partial view of one piece of an exemplary collar installed on a socket housing.

FIG. 4 depicts an exemplary LED bulb having cooling fins.

FIGS. 5A-B depict two pieces of exemplary collar having a mechanical interlock for joining the pieces together.

FIG. 6A depicts a top view of one piece of an exemplary collar.

FIG. 6B depicts a top view of one piece of an exemplary collar.

FIG. 6C depicts a top view of two pieces of an exemplary collar coupled by a mechanical interlock.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

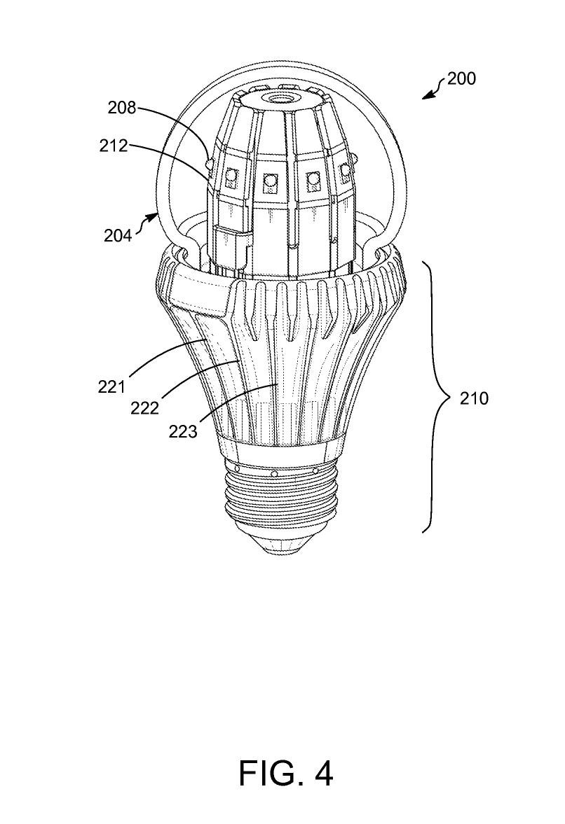

The system described herein is directed to an anti-theft collar configured to prevent an LED bulb from being removed from the socket housing of a lighting fixture. The anti-theft collar specially configured for installation with an LED bulb having an array of cooling fins located around the base of the LED bulb. As described in more detail below with respect to FIG. 4, the cooling fins typically facilitate the dissipation of heat generated by the LEDs through passive convection with the surround air. The cooling fins of the LED bulb assist in removing heat from the LED bulb, which may prevent overheating of the LEDs and help extend the life of the components of the LED bulb.

### 1. Anti-Theft Collar

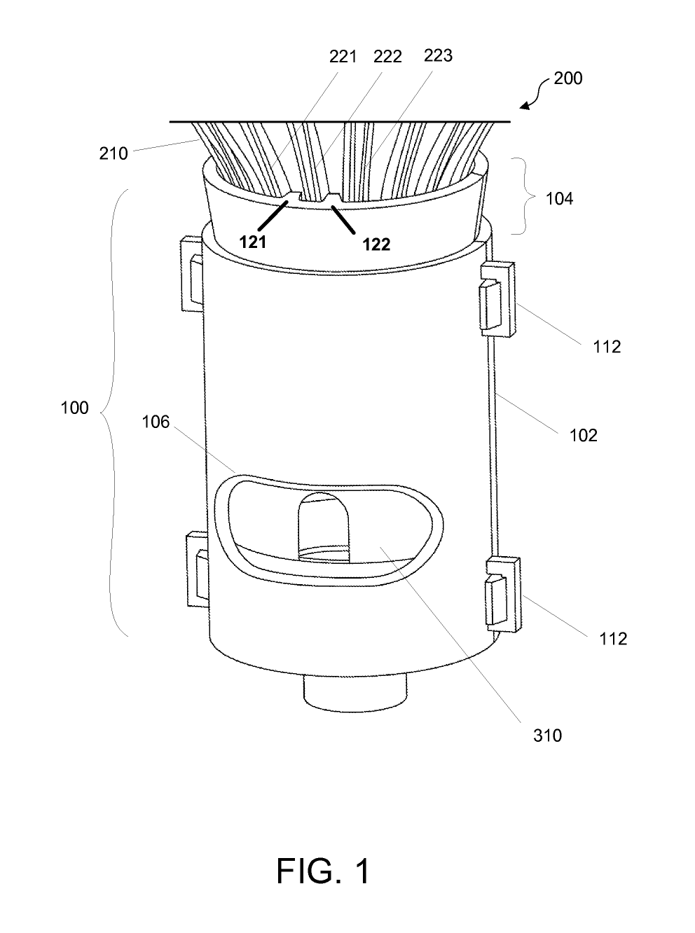

FIG. 1 depicts an exemplary (anti-theft) collar installed on a lighting fixture. As shown in FIG. 1, the collar 100 can be used to secure an LED bulb 200 having an array of cooling fins (221, 222, 223) located on the base 210 of the LED bulb 200. In this example, the cooling fins (221, 222, 223) perform dual functions: first, the cooling fins (221, 222, 223) facilitate dissipation of heat generated by the LEDs, and second, the cooling fins (221, 222, 223) provide a mechanical engagement for securing the LED bulb 200 using the collar 100.

In this example, the cooling fins (221, 222, 223) mechanically engage with the collar 100, when it is installed around a socket housing 310 of a lighting fixture. As shown in FIG. 1, the collar 100 includes a wall portion 102 having a cylindrical shape enclosing the socket housing 310. As explained in more detail below, the cooling fins (221, 222, 223) mechanically engage with the collar 100 to impede rotation of the collar 100 with respect to the LED bulb 200. As explained in more detail below, the collar 100 also includes one or more features that impedes motion between the collar 100 (and LED bulb 200) with respect to the lighting fixture, thereby preventing removal of the LED bulb 200.

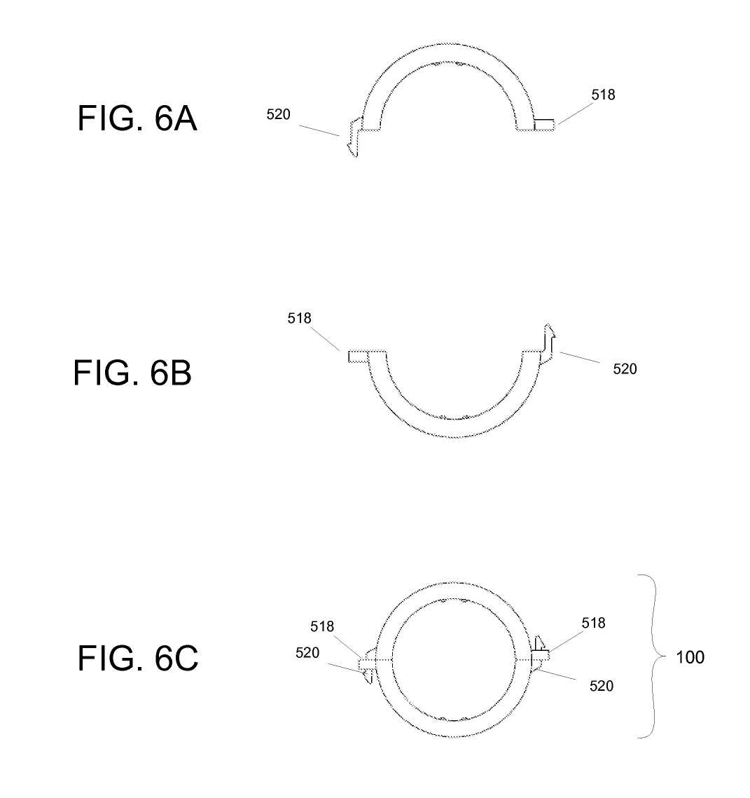

In this case, the collar 100 is formed from two semi-cylindrical pieces that are joined together using multiple mechanical interlocks 112. As described in more detail below with respect to FIGS. 6A-C, the mechanical interlocks 112 include a tab-in-slot configuration to facilitate installation on a lighting fixture after an LED bulb 200 has been screwed into the socket housing 310. The mechanical interlocks also include a locking feature that prevents or deters removal of the collar 100 after it has been installed.

As shown in FIG. 1, the collar 100 includes an upper portion 104 that extends from one end of the wall portion 102. In this case, the upper portion is tapered outward to accommodate the base 210 of the LED bulb 200, which is generally cone-shaped. The upper portion 104 typically extends beyond the top of the socket housing 310 and at least partially encloses the base 210 of the LED bulb 200. The upper portion 104 in this example overlaps a portion of the cooling fins (221, 222, 223), but also leaves a significant portion of the cooling fins (221, 222, 223) exposed to the surrounding air. This helps to minimize the impact of the collar 100 on the cooling fin's function as a passive convective cooling element. In some cases, the upper portion 104 leaves more than 50% of the cooling fin surface area exposed to the surrounding air when the collar 100 is installed on the LED bulb 200. In some cases, the upper portion 104 leaves more than 75% of the cooling fin surface area exposed to the surrounding air when the collar 100 is installed on the LED bulb 200. In some cases, the upper portion 104 leaves more than 90% of the cooling fin surface area exposed to the surrounding air when the collar 100 is installed on the LED bulb 200.

The upper portion 104 includes at least one rib (121, 122) located on the inner, bulb-facing surface. As shown in FIG. 1, the ribs (121, 122) extend inward toward the LED bulb 200. In this example, the upper portion 104 includes two pairs of ribs, the pairs located approximately 180 degrees from each other. Only one pair (121, 122) are visible in the view depicted in FIG. 1. The ribs (121, 122) are configured to mechanically engage with one or more cooling fins (221, 222, 223) of the LED bulb 200 when the collar 100 is installed, thereby preventing rotation of the LED bulb 200 with respect to the collar 100. In this case, each rib (121, 122) is formed from a protrusion that extends from and is substantially perpendicular to the inner surface of the upper portion 104 of the collar 100. In this example, each rib of the pair of ribs (121, 122) is approximately the same thickness as one or more of the cooling fins (221, 222, 223).

The pair of ribs (121, 122) are separated by a gap that is approximately the width a cooling fin (221, 222, 223) on the LED bulb 200. In some cases, the gap is slightly smaller than the width of a cooling fin 221 resulting in a slight deformation of the ribs (121, 122) when the collar 100 is installed on the LED bulb 200. This enhances the mechanical engagement between the cooling fin 221 and the collar 100 and also eliminates play between the two elements. In other cases, the gap between the pair of ribs (121, 122) may be slightly larger than the width of the cooling fin 221. A gap that is slightly larger ensures that the cooling fin 221 will fit within the gap between the pair of ribs (121, 122) while accounting for normal variations in size due to manufacturing tolerances.

The thickness of the rib (121, 122) (width of the protrusion) is approximately the same as the gap between each of the cooling fins (221, 222, 223) on the LED bulb 200. More specifically, the thickness of the rib (121, 122) is slightly less than the gap between each of the cooling fins (221, 222, 223). This ensures that the rib (121, 122) will fit between the cooling fins (221, 222, 223) given variations in size due to manufacturing tolerances. If the rib (121, 122) is slightly narrower than the gap between the cooling fins (221, 222, 223), the mechanical engagement between the rib (121, 122) and the cooling fins (221, 222, 223) may be enhanced. In some cases, the thickness of the rib is at least 90% of the gap between the cooling fins. In some cases, the thickness of the rib is at least 95% of the gap between the cooling fins.

In the example depicted in FIG. 1 the pair of ribs (121, 122) are configured to mechanically engage with three cooling fins (221, 222, 223) on the LED bulb 200. Specifically, both ribs (121, 122) are configured to mechanically engage a central cooling fin 222 that is located between the pair of ribs (121, 122) when the collar 100 is installed around the LED bulb 200. The right rib 122 is also configured to mechanically engage a first adjacent cooling fin 223 that is located to the right of pair of ribs (121, 122) when the collar 100 is installed around the LED bulb 200. The left rib 121 is also configured to mechanically engage a second adjacent cooling fin 221 that is located to the left of pair of ribs 121,122 when the collar 100 is installed around the LED bulb 200.

By way of example, either side of either rib (121, 122) may come in contact or mechanically engage with an adjacent cooling fin (221, 222, 223), depending on the position of the collar 100 with respect to the LED bulb 200. For example, if the collar 100 is rotated slightly clockwise with respect to the LED bulb 200, a left-facing side of the rib 121 may come in contact with the adjacent cooling fin 221 located to the left of the rib 121. If the collar 100 is rotated slightly counter-clockwise with respect to the LED bulb 200, a right-facing side of the same rib 121 may come in contact with the central cooling fin 222 to the right of the rib 121. This allows each rib (121, 122) to mechanically engage with multiple cooling fins (221, 222, 223) to further prevent the collar 100 from rotating with respect to the LED bulb 200.

In the present example, the rib (121, 122) is formed from a protrusion having a rectangular cross section. The walls of the rib (121, 122) are tapered slightly inward (less than 5 degrees) to facilitate installation on the cooling fin 221 of the LED bulb 200. The drafted walls of the rib (121, 122) may also facilitate manufacturing the collar using injection molding techniques. In other examples, the rib (121, 122) may be formed from a protrusion having walls that are tapered more than 5 degrees. A more steeply tapered rib (121, 122) may acts as a wedge between the cooling fins 221 when installed, further enhancing the mechanical engagement between the collar 100 and the LED bulb 200.

As shown in FIG. 1, the collar 100 also includes an opening 106 formed in the wall portion 102. In general, the opening 106 includes a void or hole in the wall portion 102 of the collar 100. A key of the light fixture may protrude through the opening 106 when the collar 100 is installed. The key 312 may include, for examples, a turn knob that is used to control the power and/or power level supplied to the LED bulb 200. In other examples, the key may include a push/pull-type switch for controlling the power to the LED bulb 200. The opening 106 in the wall portion 102 serves two purposes. First, the opening 106 permits external access to the key. Second, the opening 106 is configured to mechanically engage with the key to prevent rotation of the collar 100 with respect to the socket housing 310 of the lighting fixture.

In this example, the opening 106 is configured to encircle a key when the collar 100 is installed in the socket housing 310. The opening 106 is substantially oval-shaped and is at least as large as the largest portion of the key, which facilitates installation of the collar 100 without having to remove the key or deform the collar 100. However, in other embodiments, the opening 106 may only partially encircle the key and have a size that is slightly larger than a shaft portion of the key. For example, the opening 106 may be formed from a u-shaped channel in the wall portion 102 of the collar 100 that is configured to slide around the key during installation. The size, shape, and location of the opening 106 may vary depending on the configuration of key and socket housing 310. In some embodiments, the collar 100 may not have a lower opening, if, for example, the collar is used on a light fixture that does not have a key. In this case, the key cannot be used to prevent the collar 100 from rotating with respect to the light fixture 300. However, for cases where the light fixture does not include a key 312, the collar 100 may include one or more additional features that prevent the LED bulb 200 from being removed from the light fixture. For example, the lower portion of collar 100 may be configured to engage with a lower surface of the socket housing to prevent the removal of the collar 100 and LED bulb 200 from the lighting fixture.

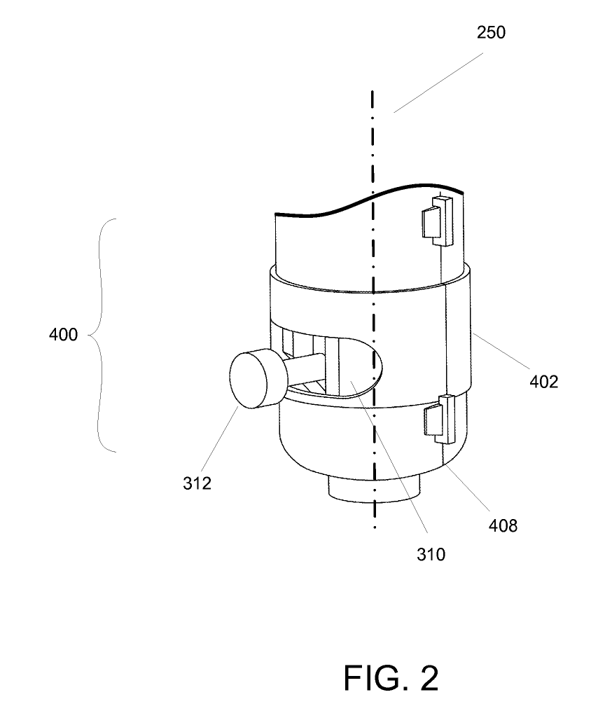

FIG. 2 depicts part of an exemplary collar 400 that includes a lower portion 408 extending from one end of the wall portion 302. While the collar 400 depicted in FIG. 2 is installed around a socket housing 310 having a key 312, the key 312 may not be necessary to inhibit relative motion between the collar 400 and the socket housing 310 of the lighting fixture. In this case, the lower portion 408 is configured to prevent the LED bulb and collar 400 (which are mechanically connected) from being removed from the socket housing 310 of the lighting fixture. Specifically, the lower portion 408 prevents the collar 400 and the LED bulb from being moved along the central axis 250 of the LED bulb and being pulled completely out of the socket housing 310. In this example, the lower portion 408 is formed from a portion of both pieces of the collar 400 that extend from the bottom edge of the wall portion 402 to form an inverted dome-shaped structure. The lower portion 408 is configured to curve around the bottom of the socket housing 310 of the light fixture when installed. In this example, the lower portion 408 also forms a hole or opening for the passage of wires and/or the post used to connect the socket housing with other parts of the lamp or appliance. In this example, the wall portion 402 and lower portion 408 together completely enclose the socket housing 310. In an alternative embodiment, the lower portion may be formed from another shape. For example, the lower portion may extend from one end of the wall portion at a 90 degree angle from the wall portion to form a flat-bottomed lower portion. The lower portion may also be formed from one or more finger-like protrusions configured to inhibit motion of the collar along the central axis 250 of the LED bulb.

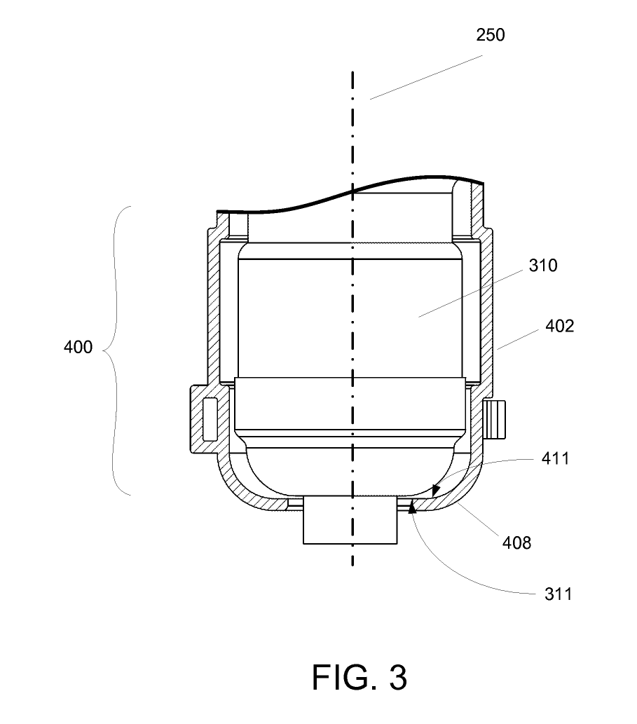

In the example depicted in FIGS. 2 and 3, the lower portion 408 is configured to engage with the socket housing 310 to inhibit motion of the collar 400 with respect to the socket housing 310 in a direction along a central axis 250 of the LED bulb. This prevents the collar 400 and LED bulb from being unscrewed and removed from the socket housing 310.

FIG. 3 depicts part of one piece of an exemplary collar 400 installed around a socket housing 310 and LED bulb (not shown in this view). As shown in FIG. 3, the collar 400 includes a lower portion 408 that extends from one end of the wall portion 402 to form an inverted dome-shaped structure that encloses the lower portion of the socket housing 310. The lower portion 408 includes an upper surface 411 that is configured to engage with an opposing lower surface 311 of the socket housing 310 to inhibit motion of the collar in a direction along a central axis of the LED bulb 250. The engagement between the upper surface 411 of the lower portion 408 and the opposing lower surface 311 of the socket housing 310 prevents the LED bulb and the collar from being removed from the lighting fixture. In this example, the LED bulb is prevented from becoming completely unscrewed from the socket housing 310 because the upper surface 411 of the lower portion 408 comes in contact with the lower surface 311 of the socket housing 310 limiting the movement of the collar 400 with respect to the socket housing 310.

As shown in FIG. 3, the lower portion 408 also forms a hole or opening to allow the socket housing 310 to be attached to the rest of the lighting fixture. The hole or opening also allows for wires or other electrical connections to be routed to the socket housing 310.

In an alternative embodiment, the lower portion may not be a fully revolved dome-shaped structure. For example, the lower portion may be formed from two or more finger-shaped structures that extend from the bottom end of the wall structure 402 towards the central axis 250. In this case, each finger-shaped structure includes an upper surface that is configured to engage with the lower surface of the socket housing to inhibit motion of the collar in a direction along the central axis 250.

### 2. LED Bulb with Cooling Fins

The collar described above is particularly suitable for use with an LED bulb having external cooling fins. FIG. 4 depicts a finned LED bulb 200 that may be secured using one of the collars (100 400), described above. As shown in FIG. 4, the LED bulb 200 includes a base 210 and a shell 204 encasing the various components of the LED bulb 200. The shell 204 is attached to the base 210 to form an enclosed volume. An array of LEDs 208 is attached to LED mounts 212 and is disposed within the enclosed volume.

The LED bulb 200 includes several components for dissipating the heat generated by the LEDs 208. For example, as shown in FIG. 4, the LED bulb 200 includes one or more LED mounts 212 for mounting the LEDs 208. The LED mounts 212 may be made of any thermally conductive material, such as aluminum, copper, brass, magnesium, zinc, or the like. Since the LED mounts 212 are formed from a thermally conductive material, heat generated by the LEDs 208 may be conductively transferred to the LED mounts 212. Thus, the LED mounts 212 may act as a heat-sink or heat-spreader for the LEDs 208.

The LED mounts 212 are attached to the bulb base 210, thus allowing the heat generated by the LEDs 208 to be conducted to other portions of the LED bulb 200. The LED mounts 212 and bulb base 210 may be formed as one piece or multiple pieces. The bulb base 210 may also be made of a thermally conductive material and attached to the LED mounts 212 so that heat generated by the LEDs 208 is conducted into the bulb base 210 in an efficient manner. The bulb base 210 is also attached to the shell 204, and can thermally conduct with the shell 204.

The bulb base 210 includes thermally conductive cooling fins (221, 222, 223) arranged radially around the base 210. Heat generated by the LEDs 208 is transmitted to the cooling fins (221, 222, 223) through the LED mounts 212 and the bulb base 210. The cooling fins (221, 222, 223) provide additional surface area that allows heat to be dissipated to the surrounding environment. In this example, the cooling fins (221, 222, 223) are configured to facilitate passive convective cooling with the surrounding air by forming multiple (vertical) convective channels. As previously described with respect to FIG. 1, the cooling fins (221, 222, 223) also provide mechanical engagement between the LED bulb 200 and (anti-theft) collar to inhibit rotation of the LED bulb 200 with respect to the collar.

### 3. Collar Installation and Removal

As previously mentioned, exemplary collar 100 is formed from two pieces for installation and removal. To install a two-piece collar, each piece of the collar is typically placed on either side of the base of an LED bulb installed within a light fixture. The pieces of the collar are aligned with cooling fins on the LED bulb so that corresponding ribs on the collar mechanically engage with the LED bulb. Additionally, the pieces of the collar are aligned so that, if the collar includes an opening in the wall portion for a key, the opening aligns with the key on the light fixture to allow the key to protrude through the opening when the collar is installed.

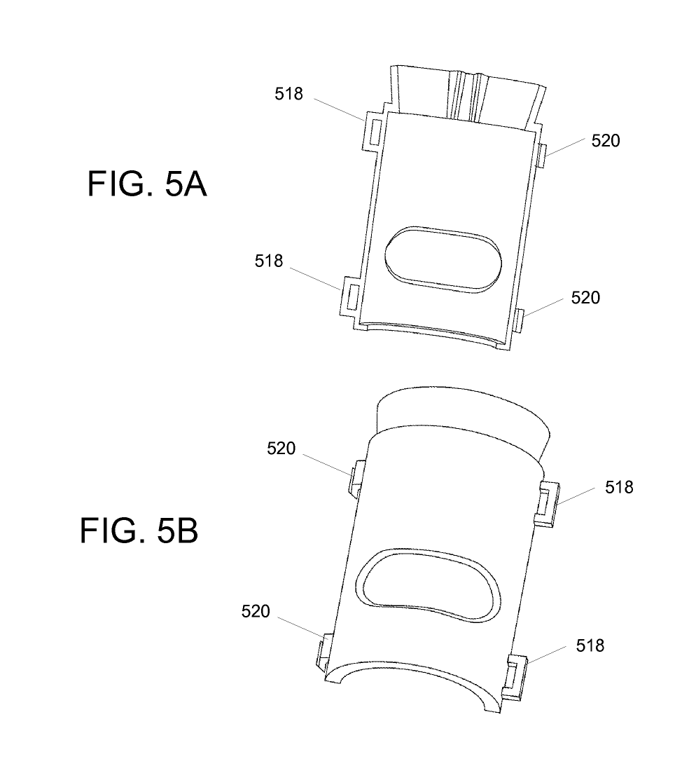

The two pieces of the collar are then pressed together around the base of the LED bulb and the light fixture to abut the edges of the two pieces of the collar and engage the mechanical interlocks (described in more detail below with respect to FIGS. 5A-B and 6A-C). When installed in this manner, the collar encloses at least a portion of a socket housing of the light fixture and at least a portion of the base of the LED bulb. The pieces of the collar may be symmetric or have identical geometry. In some cases, the pieces of the collar are not symmetric. Non-symmetric or non-identical geometry may further inhibit the removal of the collar by preventing disengagement of the mechanical interlocks by shifting of the pieces with respect to each other.

FIGS. 5A-B depict two pieces of exemplary collar 100 having a mechanical interlock for joining the pieces. Each piece of the collar 100 includes two tabs 520 and two slots 518. The tabs 520 on one piece of the collar 100 slide into corresponding slots 518 on the other mating piece of the collar 100 to join and lock the pieces together. The tabs 520 are configured such that they are easy to insert but difficult to disengage once inserted, thus serving as a theft deterrent. In this example, the tabs 520 include a beveled leading edge to facilitate insertion into a corresponding slot 518. The tabs 520 also include a catch barb that engages with the slot 518 when installed to prevent disassembly of the two pieces.

As an additional deterrent, in this example, separation of the two pieces of the collar requires disengagement of multiple tabs 520 at the same time. Simultaneous disengagement may be made more difficult if the two pieces do not have interlocks having exactly the same geometry. For example, the tabs may be slightly offset to prevent the two pieces from being disassembled by merely shifting the pieces.

FIGS. 6A-B depict top views of two pieces of an anti-theft collar when the pieces are separated. FIG. 6C depicts a top view of the pieces when they are interlocked by sliding the tabs 520 into the slots 518. Other types of mechanical interlocks may be used to join the pieces of the collar. These may include, for example, a variety of fasteners, clasps, threaded connectors, or adhesives. In some embodiments, the mechanical interlock may comprise a flexible or inflexible band that encloses the collar. In some embodiments, the mechanical interlock may not be removable.

As discussed above, exemplary collar 100 is designed to comprise two pieces to enable installation and removal. However, other collar designs that enable installation and removal are also possible. For example, a collar may comprise more than two pieces that can be locked together and detached from each other. The pieces of the collar may also hinge at one or more joints to enable them to pivot with respect to each other rather than detaching from each other completely. One or more pieces may also be connected to each other by a material or joint that provides for expansion between the sections, such as a flexible mesh or elastic.

The anti-theft collar may be fabricated from a variety of materials. These may include, for example, various forms of polycarbonates, metals, woods, or other materials that provide suitable strength and rigidity to prevent cracking or breaking of the collar by hand. The anti-theft collar may be fabricated using an injection molding, a machining, or another fabrication technique. The anti-theft collar may be fabricated from a single type of material, or the collar may be fabricated from multiple materials. For example, the mechanical interlocks may be fabricated from a different material than the walls of the collar, and attached to the collar using an adhesive, fastener, or other bonding technique.

The examples above are intended to be illustrative rather than comprehensive. A person having skill in the art will recognize that there are many possible collar designs and materials that will achieve the desired result of preventing removal of an LED bulb from a light fixture.

What is claimed is:

1. An anti-theft collar for preventing removal of a light-emitting diode (LED) bulb when installed in a socket housing of a light fixture, the LED bulb having a plurality of cooling fins, the anti-theft collar comprising:
a wall portion configured to enclose at least a portion of the socket housing;
an upper portion extending from a first end of the wall portion;
a pair of ribs extending inward from an inner surface of the upper portion, the pair of ribs configured to mechanically engage with at least one cooling fin of the LED light bulb and to inhibit rotation of the LED light bulb with respect to the anti-theft collar when the anti-theft collar is installed; and
an opening in the wall portion, the opening configured to at least partially encircle a key of the light fixture to inhibit rotation of the anti-theft collar with respect to the light fixture when the anti-theft collar is installed.

2. The anti-theft collar of claim 1, wherein the pair of ribs are perpendicular to the inner surface of the upper portion.

3. The anti-theft collar of claim 1, wherein the pair of ribs are separated by a gap that is approximately the width of one cooling fin of the plurality of cooling fins.

4. The anti-theft collar of claim 1, wherein the pair of ribs are separated by a gap that is approximately the width of one cooling fin of the plurality of cooling fins, and the thickness of the ribs is approximately the same as a uniform gap between each of the plurality of cooling fins.

5. The anti-theft collar of claim 1, wherein each rib of the pair of ribs is approximately the same thickness as a fin of the plurality of cooling fins.

6. The anti-theft collar of claim 1, wherein the pair of ribs are configured to mechanically engage with:
a central cooling fin of the plurality of cooling fins, the central cooling fin located between the pair of ribs when the collar is installed around the LED bulb;
a first adjacent cooling fin of the plurality of cooling fins, the first adjacent cooling fin located to the right of pair of ribs when the collar is installed around the LED bulb; and
a second adjacent cooling fin of the plurality of cooling fins, the second adjacent cooling fin located to the left of pair of ribs when the collar is installed around the LED bulb.

7. The anti-theft collar of claim 1, the anti-theft collar further comprising:
a lower portion extending from a second end of the wall portion opposite to the first end, the lower portion having an upper surface configured to engage with an opposing lower surface of the socket housing to inhibit motion of the anti-theft collar in a direction along a central axis of the LED bulb.

8. The anti-theft collar of claim 1, wherein the anti-theft collar is formed from two pieces that are configured to be mechanically joined by one or more mechanical interlocks.

9. The anti-theft collar of claim 8, wherein each mechanical interlock comprises:
a tab portion on a first of the two pieces; and
a slot portion on a second of the two pieces, wherein the tab portion and the slot portion are configured to interlock with each other.

10. An anti-theft collar for preventing removal of a light-emitting diode (LED) bulb when installed in a socket housing of a light fixture, the LED bulb having a plurality of cooling fins, the anti-theft collar comprising:
a wall portion configured to enclose at least a portion of the socket housing;
an upper portion extending from a first end of the wall portion;
a pair of ribs extending inward from an inner surface of the upper portion, the pair of ribs configured to mechanically engage with at least one cooling fin of the LED light bulb and to inhibit rotation of the LED light bulb with respect to the anti-theft collar when the anti-theft collar is installed; and
a lower portion extending from one end of the wall portion, the lower portion having an upper surface configured to engage with an opposing lower surface of the socket housing to inhibit motion of the anti-theft collar in a direction along a central axis of the LED bulb.

11. The anti-theft collar of claim 10, wherein the pair of ribs are perpendicular to the inner surface of the upper portion.

12. The anti-theft collar of claim 10, wherein the pair of ribs are separated by a gap that is approximately the width of one cooling fin of the plurality of cooling fins.

13. The anti-theft collar of claim 10, wherein the pair of ribs are separated by a gap that is approximately the width of one cooling fin of the plurality of cooling fins, and the thickness of the ribs is less than a uniform gap between each of the plurality of cooling fins.

14. The anti-theft collar of claim 10, wherein each rib of the pair of ribs is approximately the same thickness as a fin of the plurality of cooling fins.

15. The anti-theft collar of claim 10, wherein the pair of ribs are configured to mechanically engage with:
a central cooling fin of the plurality of cooling fins, the central cooling fin located between the pair of ribs when the collar is installed around the LED bulb;
a first adjacent cooling fin of the plurality of cooling fins, the first adjacent cooling fin located to the right of pair of ribs when the collar is installed around the LED bulb; and
a second adjacent cooling fin of the plurality of cooling fins, the second adjacent cooling fin located to the left of pair of ribs when the collar is installed around the LED bulb.

16. The anti-theft collar of claim 10, wherein the anti-theft collar is formed from two pieces that are configured to be mechanically joined by one or more mechanical interlocks.

17. The anti-theft collar of claim 16, wherein each mechanical interlock comprises:
a tab portion on a first of the two pieces; and
a slot portion on a second of the two pieces, wherein the tab portion and the slot portion are configured to interlock with each other.
